(19) United States
(12) Patent Application Publication
(10) Pub. No.: US 2018/0330319 A1
(43) Pub. Date: Nov. 15, 2018

(54) AUTONOMOUS VEHICLES FOR EFFICIENT TRANSPORTATION AND DELIVERY OF PACKAGES

(71) Applicants: Biyonka LIANG, Newport Coast, CA (US); Ping LIANG, Newport Coast, CA (US)

(72) Inventors: Biyonka LIANG, Newport Coast, CA (US); Ping LIANG, Newport Coast, CA (US)

(73) Assignee: Ping LIANG, Newport Coast, CA (US)

(21) Appl. No.: 15/912,820

(22) Filed: Mar. 6, 2018

Related U.S. Application Data
(63) Continuation-in-part of application No. 15/592,151, filed on May 10, 2017.

(51) Int. Cl. G06Q 10/08; G05D 1/02; G05D 1/00

(52) U.S. Cl. CPC G06Q 10/0832; G05D 1/0088; G05D 1/0287; G06Q 10/08355

(57) ABSTRACT

This invention describes a method, the information processing system and the autonomous vehicles for transferring of a package from one traveling autonomous vehicle to another traveling autonomous vehicle. An information processing system computes an optimized plan for two or more traveling autonomous vehicles to carry out a transfer of a package from the first traveling autonomous vehicle to a second traveling autonomous vehicle, communicates the plan to the traveling autonomous vehicles, and the traveling autonomous vehicles executes the plan and completes the transfer while traveling at normal speed. This invention will lead to significantly more efficient transportation and delivery of packages, reducing the need to transportation hubs, transportation time and/or energy consumption.

### FIELD OF INVENTION

This invention relates generally to the control of two or more traveling autonomous vehicles and delivery of packages, and more particularly, to the control two or more traveling autonomous vehicles for delivery of goods and the mechanism for transferring a package from one autonomous vehicle to another while both are traveling, and the associated communication, control and information management systems, to enable efficient routing and delivery of packages transported by autonomous vehicles.

### BACKGROUND

Autonomous vehicles are expected to become a reality in the near future. It will free humans from the attention-demanding task of driving and allow them to work or play while traveling in autonomous vehicles. One basic human need is socializing. Social networking is an important part of current day life. Although online social networking is popular, it is no replacement of meeting in-person and in-person socializing is still desired by many. Our previous invention application Ser. No. 15/592,151 “Autonomous Vehicles as a Social Network Platform” filed on May 10, 2017 focused on the face to face socializing aspect of physically connecting travelling autonomous vehicles, however the core technology described in that application applies equally well to physically connecting travelling autonomous vehicles for the purpose of more efficient transportation and delivery of goods or packages. The current application is fundamentally the same invention as our invention described in Ser. No. 15/592,151 with the difference being replacing the word “package” with the word “package” or “goods”.

### BRIEF DESCRIPTION OF DRAWINGS

Abbreviations used in the following list of drawings are defined in the next section which provides the detailed description of the embodiments of the invention.

FIG. 1 shows an embodiment of an information processing system that plans, manages and controls the transfer of package(s) from a first traveling autonomous vehicle to a second traveling autonomous vehicle.

FIG. 2 shows embodiment of an autonomous vehicle capable of joining, connecting or contacting with one or more other autonomous vehicles for transferring of package(s) from a first traveling autonomous vehicle to a second traveling autonomous vehicle.

FIG. 3 shows the rear view of the transfer of a package from a first traveling autonomous vehicle to a second traveling autonomous vehicle using robotic arms.

FIG. 4 shows one implementation of a mechanical joining mechanism for two traveling autonomous vehicles to connect in a front-back connection, and/or transferring of a package from one traveling autonomous vehicle to another traveling autonomous vehicle.

### DETAILED DESCRIPTION

Reference may now be made to the drawings wherein like numerals refer to like parts throughout. Exemplary embodiments of the invention may now be described. The exemplary embodiments are provided to illustrate aspects of the invention and should not be construed as limiting the scope of the invention. When the exemplary embodiments are described with reference to block diagrams or flowcharts, each block may represent a method step or an apparatus or system element for performing the method step. Depending upon the implementation, the corresponding apparatus element may be configured in hardware, software, firmware or combinations thereof.

In the following, an autonomous vehicle is a vehicle that is driven by an autonomous system without the need of intervention from a human driver either all the time or part of the time. It may also be referred to as an autonomous driverless vehicle. The term “autonomous vehicle” is used to indicate either an autonomous vehicle that is scheduled to transport a package and/or a package on a planned trip or an autonomous vehicle this currently traveling with the package and/or package onboard on an ongoing trip, while the term a “traveling autonomous vehicle” indicate only an autonomous vehicle this currently traveling with the package and/or package onboard on an ongoing trip. Correspondingly, packages in an autonomous vehicle may mean packages that will be traveling in an autonomous vehicle when the trip starts, or packages that are currently travelling in an autonomous vehicle. An autonomous vehicle of this invention may travel on land, air, or water, or a combination of them. An example is an autonomous aerial vehicle, commonly referred to as a drone. A cluster of autonomous vehicles means two or more autonomous vehicles that are connected by a mechanical joining mechanism such that they travel as one integrated entity. The words package, goods or physical item are used interchangeably.

When a first autonomous vehicle is to deliver a package to a recipient, in addition to schedule it to be delivered to an address, a parked vehicle, an embodiment of this invention is a method and the associated intelligent logistics systems that schedule, control and complete the delivery of the package to the recipient while he is traveling in a second autonomous vehicle. This offers greater flexibility and convenience. A person may place an order for an item while traveling in the second autonomous vehicle, and the item may be delivered to him by the first autonomous vehicle, either a land vehicle or an aerial drone, while the person is traveling at high speed by having the two traveling autonomous vehicles physically connect or come into contact for a period of time to complete the transfer of an physical item from the first delivery autonomous vehicle to the second traveling autonomous vehicle carrying the intended recipient of the physical item. This is especially useful when the delivery requires the signature of the recipient. Many of us have the experience of repeatedly missing the delivery of a signature required package because we are not at home when the delivery arrives. This invention will completely eliminate that because the intelligent logistics system will be able deliver time-critical signature-required package to you even when you are traveling at high speed.

In another embodiment of this invention, a first traveling autonomous vehicle carrying packages and a second traveling autonomous vehicle physically connect or come into contact; the first traveling autonomous vehicle transfers one or more packages to the second traveling autonomous vehicle which accepts the one or more packages transferred from the first traveling autonomous vehicle, whereas the first traveling autonomous vehicle is traveling to a first destination and the second traveling autonomous vehicle is traveling to a second destination, and the packages transferred from the first traveling autonomous vehicle to the second traveling autonomous vehicle is to be transported to the second destination or a destination that is closer to the second destination or can be more efficiently transported or delivered by the second traveling autonomous vehicle. The second traveling autonomous vehicle is typically also carrying packages and when the first and second traveling autonomous vehicles physically connect or come into contact, the two traveling autonomous vehicles may exchange packages, i.e., the second traveling autonomous vehicle may also transfer packages to the first autonomous vehicle whereas the packages transferred from the second traveling autonomous vehicle to the first traveling autonomous vehicle is to be transported or delivered to the first destination or a destination that is closer to the first destination or can be more efficiently transported or delivered by the first traveling autonomous vehicle. This embodiment will significantly enhance the efficiency of the shipping, transportation and delivery services. At present, these services build many hubs, and a package from a origin to a destination may need to be transported to one or more hubs before reaching the destination, often transiting through multiple hubs, getting unloaded from one vehicle and reloaded to another vehicle at each hub. At a hub, the packages intended for one or more destinations on a vehicle are unloaded, sorted and reloaded onto other vehicles traveling to other hubs or the final destination. This is because it is impractical to have every package transported a single vehicle carry the package from origin to destination. The hubs require spaces, building, energy, people and/or machinery to operate. The transporting vehicles travel extra distances to the hubs, consuming more energy. With this invention, packages are transferred from one traveling autonomous vehicle to another, both can be traveling at full speed. An intelligent transportation logistics system manages the traveling autonomous vehicles and the transfer of packages among them. The system optimizes the route of the traveling autonomous vehicles and the location of transfer between traveling autonomous vehicles to reduce transportation time, traveling distance and/or energy consumption, all dynamically in real-time. It uses information on where the packages are being transported in the system, what traveling autonomous vehicles are nearby, the destinations of the packages they are carrying to make decisions. It can dynamically updates the routes of traveling autonomous vehicles to optimize the overall efficiency and/or guarantee delivery time of the packages.

In one embodiment, the first and the second traveling autonomous vehicles physically connect into one virtual vehicle to complete the transfer or delivery one or more packages, whereas the two connected vehicles travel as one combined vehicle under common or coordinated control. In another embodiment, one or both of the first and the second traveling autonomous vehicles extend out a chute or conveyor for transferring packages from one traveling autonomous vehicle to the other, and the two traveling autonomous vehicles coordinate their control and drive to maintain the connection of the chute or conveyor with the two traveling autonomous vehicles so that it remains connected and stable during the transfer or delivery. In all embodiments, the two traveling autonomous vehicles must first establish communication, align their travel, comes into proximity, establish physical contact or connection, maintain communication and coordinate travel at the same or approximately the same speed and direction after the contact or connection is established, then complete the delivery, transfer or exchange of packages, retract the connection or contact, separate, and finally travel independently on each's own route.

When one of the traveling autonomous vehicles is an aerial vehicle and the other traveling autonomous vehicle is a land or water vehicle, the transfer or delivery of package can be accomplished by having the land or water vehicle raising an extension with a platform that carries one or more packages in the case the aerial vehicle is the recipient, or receives one or more packages when the land or water vehicle is the recipient. The traveling autonomous vehicles can then align their traveling speed and direction and the aerial vehicle can grab the package(s) on the platform or transfer the package(s) to the platform. After the completion of the transfer, the land or water vehicle lowers the platform back. Alternatively, the aerial vehicle lowers a platform with an extension, preferably rigid to avoid swinging, onto a platform or opening of the land or water vehicle to accomplish the delivery or pickup of one or more packages. After the transfer, the aerial vehicle retracts the extension and platform.

Whereas the delivery or transfer can be completed between an aerial traveling autonomous vehicle and another aerial, land or water autonomous traveling vehicle, the delivery or transfer between a land traveling autonomous vehicle and a water traveling autonomous vehicle is rare. In all cases, both traveling autonomous vehicles need to communicate, coordinate and control their traveling to be at the same or approximately the same speed and direction during the time of the physical connection or contact for the transfer of packages. When the two land traveling autonomous vehicles are physically connected, they can coordinate to drive under one common control to travel as one combined vehicle.

Another use of an aerial traveling autonomous vehicle is to bridge over traffic jam, terrain unfavorable to land vehicle, or land route that is too long compared to a point-to-point aerial route, e.g., a land route that winds around a mountain vs. a route directly over the mountain achievable by an aerial vehicle. In such cases, an aerial traveling autonomous vehicle picks up a package from a land traveling autonomous vehicle at one side, flies over the unfavorable segment and transfers the package to another land traveling autonomous vehicle at the other side, which continues the transportation of the package.

In the above described chute, conveyor belt or platform embodiments, magnetic force can be used as a force to move a package, secure a package in motion, or transfer a package by having the transferring vehicle remove or turns off the magnetic force and the receiving vehicle activate or increase a magnetic force, or move a magnetic force into place. Magnetic force has the advantage of applying force without mechanical mechanisms. The magnetic force can be achieved using permanent magnets or electromagnets.

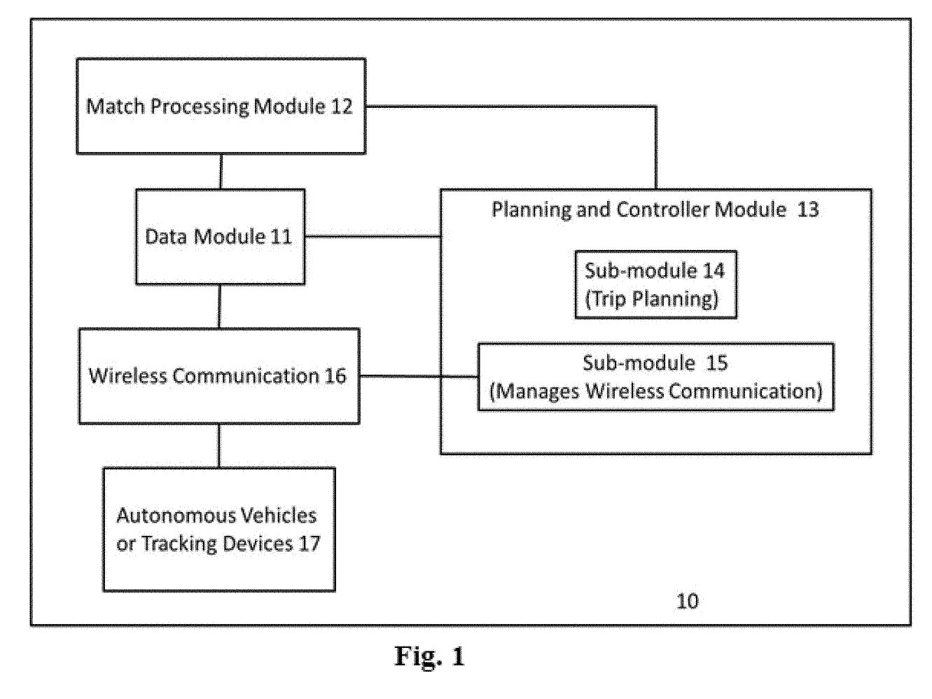

One embodiment is a method or an information processing system 10, shown in FIG. 1, that enables and manages the transfer of packages between two traveling autonomous vehicles. Block 11 represents one or more data modules or a processing step that accept and/or store information of packages that are currently being transported and the traveling autonomous vehicles they are on, and packages that are scheduled to be transported and their origin and destination. Block 12 depicts one or more optional match processing modules or a processing step that match packages that can be transported on the same vehicle, e.g., avoiding transporting bacteria samples with foods, flammable materials that need to be transported on special vehicles, etc. A match is identified when two or more packages can be transported on the same vehicle, have overlapping traveling route(s), and/or requires transportation in overlapping time.

Box 13 shows one or more planning and controller modules or a processing step that comprise several submodules or sub-processing steps, including a sub-module or processing step 14 that computes a plan for two or more autonomous vehicles carrying packages wherein the plan includes one or more of traveling route of each vehicle, start and time information of the trip of each vehicle, speed and lane position of the autonomous vehicles during the trip to enable the connection or contact of two or more traveling autonomous vehicles for the transfer of package(s), where, when and how two traveling autonomous vehicles complete a transfer. It also includes a sub-module or processing step 15 that manages the wireless communication 16 with two or more traveling autonomous vehicles and/or tracking devices 17 to collect information from and transmit information to such vehicles and/or packages, communicate information to two or more autonomous vehicles 17 for them to execute the plan, receive updates from the two or more traveling autonomous vehicles and/or tracking devices in the vehicles 17 and adapt the plan based on the received updates. When packages on a traveling autonomous vehicle have different destinations, the one or more planning and controller modules or a processing step 13 also includes in the plan where, when and how packages to one or more destinations are to be transferred to another traveling autonomous vehicle. The information processing system plans and coordinates the transfer of packages between two or more autonomous vehicles and initiates the connection or contact of the vehicles. It communicates information to the two or more autonomous vehicles for them to execute the plan.

For energy and space efficiency and for convenience, it may be preferable to use a number of small capacity autonomous vehicles each transporting a small number of packages and physically or virtually connect them into one combined group traveling together, e.g., with a rear-front connection forming a platoon, like cars in a train, when they share a route. When they are physically connected, the vehicles coordinate and drive as one, with improved aerodynamics to save energy. A traveling autonomous vehicle in the combined group will break away when its route no longer overlaps with the combined group.

In another embodiment, the one or more planning and controller modules or a processing step produce a plan in which one or more small capacity autonomous vehicles are connected to a larger capacity autonomous vehicle so that packages in the small capacity autonomous vehicle can be transferred to the larger capacity autonomous vehicle. Furthermore, the one or more planning and controller modules or a processing step include in the plan transferring of a package to a small capacity autonomous vehicle from the large capacity autonomous vehicle at a later time when route to the package's intended destination deviates from the planned route of the large capacity autonomous vehicle.

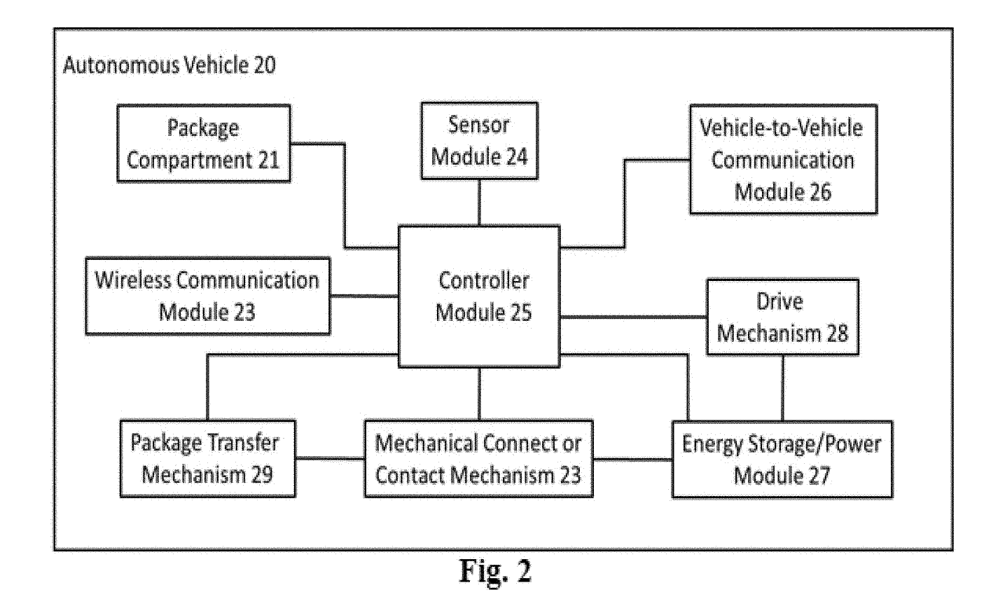

One embodiment is an autonomous vehicle capable of connecting or contact with one or more autonomous vehicles and transferring package(s) to or receiving package(s) from other traveling autonomous vehicles, whose system block diagram is shown in FIG. 2. The autonomous vehicle 20 has a package compartment 21 that can hold one or more packages. To save travel time and to avoid disruption to traffic, it is desired that autonomous vehicles can physically connect or contact for transferring package(s) from one traveling autonomous vehicle to the other while the vehicles are travelling at normal speed range. To accomplish this, the autonomous vehicle is equipped with a mechanical mechanism 23 to allow it to connect or contact with the mechanical connect or contact mechanism 23 of another autonomous vehicle while both are travelling at speed in normal operating range. The autonomous vehicle further includes a package transfer mechanism 29 that can transfer a package to and/or receive a package from another traveling autonomous vehicle. The package transfer mechanism 29 can be a sub-mechanism of the mechanical connecting or contacting mechanism 23. The package transfer mechanism 29 is also responsible for retrieving the package to be transferred from the package compartment 21, under the control of the controller module 25, which keeps a record of the locations of the packages inside the package compartment 21. The mechanical connect or contact mechanism 23 can be implemented as a chute, a conveyor belt or robotic arm, etc., that extends out from one traveling autonomous vehicle 20 and received by the mating of mechanical connect or contact mechanism 23 of another traveling autonomous traveling vehicle 20, or in symmetric implementation, both traveling autonomous vehicles extends out their mechanical connect or contact mechanism 23, which can be implemented as one side of a chute or a conveyor belt or a robotic arm, etc., and the two mechanical connect or contact mechanisms 23 joins in the case of a chute or conveyor belt. After the transfer of package(s) is completed, the mechanical connect or contact mechanisms 23 of the two vehicles disengage and retract back. In the robotic arm case, a first robotic arm, which implements both the functions of module 23 and 29, of a first traveling autonomous vehicle 20 carries and extends the package towards a second traveling autonomous vehicle, and a second robotic arm of a second traveling autonomous vehicle grabs the package, upon confirming the second robotic arm has achieved a secure hold of the package, the first robotic arm releases the package, and the second robotic arm retracts back into the second traveling autonomous vehicle, completing the transfer of the package.

There can be autonomous vehicles with different capacity, some with small package compartment holding a small number of packages, some with large package compartment holding a large number of packages. Small capacity autonomous vehicles provide energy and space efficiency and convenience to transport individual or small number of packages, while large capacity autonomous vehicles provide energy and space efficiency for transporting a large number of packages. In one embodiment, small capacity autonomous vehicles are used to collect packages from one or more origins and transfer the packages to a large capacity autonomous vehicle while both traveling at normal speed range.

The autonomous vehicle 20 contains a wireless communication module 23 to communicate with one or more information processing systems. The wireless communication can be accomplished through one or more mobile communication networks. The one or more information processing systems 10 communicates with multiple autonomous vehicles through the wireless communications modules 16 and 23 to collects information from traveling autonomous vehicles, plans the transportation of packages, manages the end-to-end transportation of packages, and sends commands to traveling autonomous vehicles to execute the needed connection or contact and transfer of package(s) from one traveling autonomous vehicle to another to optimize the overall transportation and delivery of packages.

The autonomous vehicle 20 contains a sensor module 24 that provides the sensory information needed for fully or partial autonomous driving or assisted driving, measures the spatial and temporal information of an autonomous vehicle to be joined, connected or contacted and the status of the execution of the transfer of packages. The sensor module 24 provides sensory feedback to a controller module 25 which control the autonomous vehicle 20. Furthermore, it contains a vehicle-to-vehicle communication module 26 that identifies and communicates with the autonomous vehicle to be joined, connected or contacted for transfer of package(s), to collaborate on the mechanical joining, connection, or contact and transfer of package(s). The controller module 25 has the overall control of the autonomous vehicle, is responsible for executing a trip plan, controls the process to join, connect or contact with one or more other autonomous vehicles, and the transfer of package(s). Furthermore, in a cluster of two or more joined or connected traveling autonomous vehicles, the controller module 25 of each traveling autonomous vehicle 20 works in synchrony with other controller modules and controls its drive mechanism to collaborate with the drive mechanism(s) of the other traveling autonomous vehicles in the cluster so that the cluster moves as one combined or integrated autonomous vehicle. The controller module 25 can also abort an ongoing connection or transfer procedure upon receiving a command of cancelation from one or more information processing system or when the controller module detects unfavorable conditions for making the join, connection or contact, or the transfer of package(s).

As is required of all transportation vehicles, the autonomous vehicle must be equipped with an energy storage module and/or a power module 27 that can receive power from an external source or generate power from the environment to provide the power source for a drive mechanism 28 to converts the power to produce mechanical motion to propel the autonomous vehicle.

The autonomous vehicle can further be equipped with an in-vehicle communication module 29 that communicates with tracking devices embedded with package(s) to track or monitor the package(s) on-board in the package compartment 21.

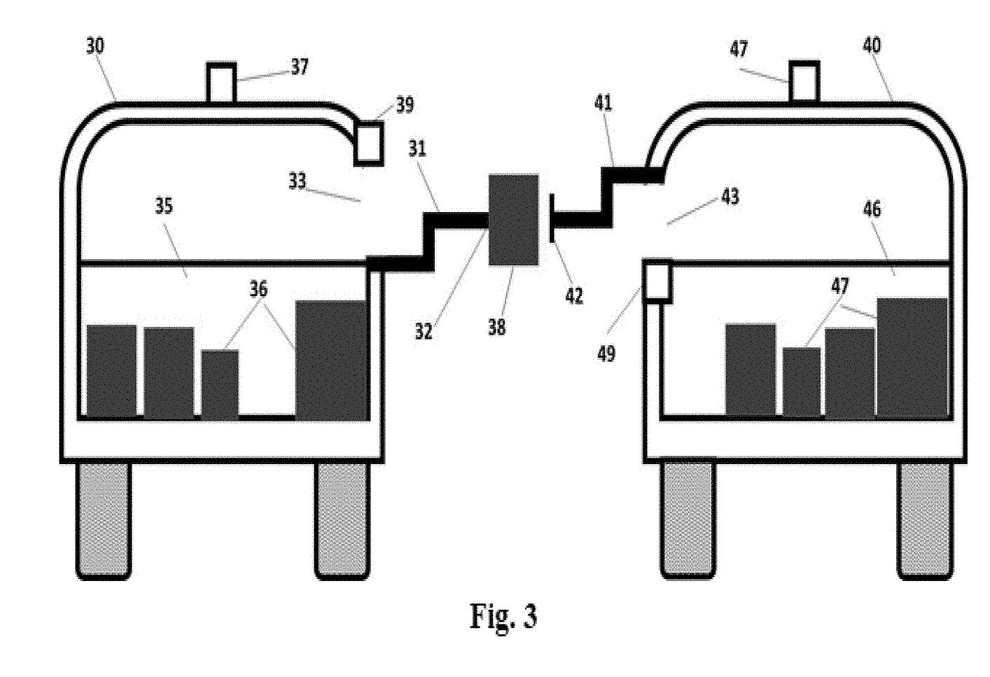

FIG. 3 shows the rear view of a first traveling autonomous vehicle 30 transferring a package 38 to a second traveling autonomous vehicle 40. The first traveling autonomous vehicle 30 uses its robotic arm 31 to retrieve a package 38 to be transferred to a second traveling autonomous vehicle 40, from its package compartment 35, which holds one or more packages 36. After the two traveling autonomous vehicles 30 and 40 are aligned and coordinated in their traveling positions, directions and speed, the two traveling autonomous vehicles each opens an opening 33 and 43. The first traveling autonomous vehicle extends out its robotic arm 31 from opening 33, whereas the robotic arm 31 holds the package to be transferred 38 using its grabber 32. The second traveling autonomous vehicle extends out its robotic arm 41 from the opening 43 and aligns its grabber 42 with the package 38. It then grabs the package 38, after which the second traveling autonomous vehicle communicates to the first traveling autonomous vehicle using its vehicle-to-vehicle wireless communication module 47 via the vehicle-to-vehicle communication module 37 that that the first traveling autonomous vehicle can control its robotic arm 31 and grabber 32 to release the package 38. After that, the robotic arm 41 retracts back, carries the package into the package compartment 46, releases the gabber to place the received package 38 along with other packages 47, if there are any. During the transfer, the sensors 39 and 49 of the two traveling autonomous vehicles monitors the process and provides feedback to the controller module 25 of each traveling autonomous vehicle to complete the alignment and transfer. The whole process is planned, managed and controlled by one or more information processing systems 10 which sends commands to and receives feedback from the traveling autonomous vehicles 30 and 40 via the wireless communication modules 16 of the information processing system and 23 of each traveling autonomous vehicle.

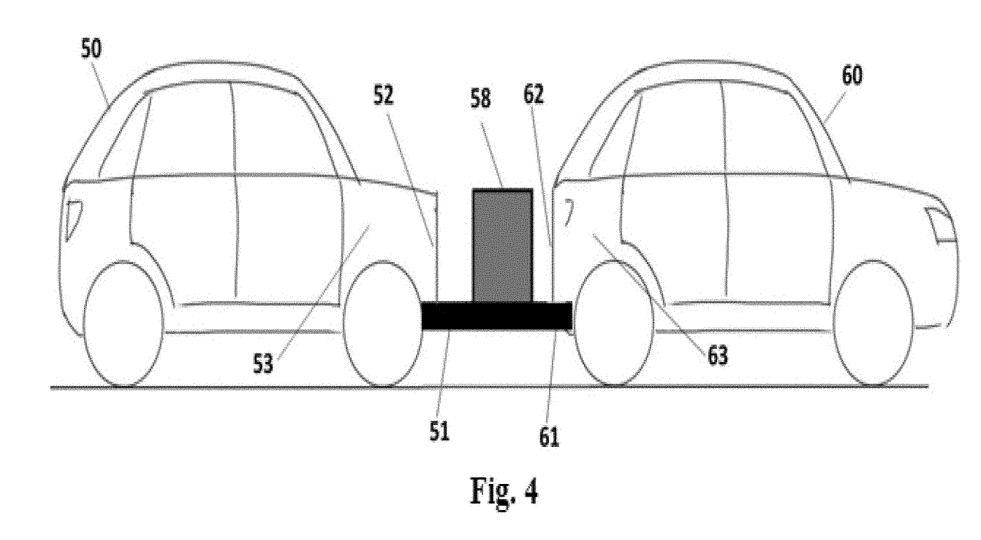

FIG. 4 shows the side view of a first traveling autonomous vehicle 60 transferring a package 58 to a second traveling autonomous vehicle 50 in a front-back mechanical join or connection. After the two traveling autonomous vehicles 50 and 60 are aligned and coordinated in their traveling positions, directions and speed, the two traveling autonomous vehicles each opens an opening 52 and 62 into their package compartments 53 and 63. Either one or both traveling autonomous vehicles 50 and 60 extends out a platform 51 through the respective openings 52 and 62. The platform 51 are secured using a joint mechanism 61 with the traveling autonomous vehicle(s). The traveling autonomous vehicle, e.g., 60, transferring a package 58 activates a mechanism, e.g., a conveyor belt or magnetic force, to move the package 58 to the other traveling autonomous vehicle, e.g., 50. After the transfer is completed, the platform 51 can retract back. In another embodiment, the platform 51 joins the two vehicles into a two-vehicle platoon so they travel together as a combined vehicle with common control. Similar to FIG. 3, the vehicle-to-vehicle wireless communication modules 26, the sensor modules 24, and the controller modules 25 of each traveling autonomous vehicle, and the whole process is planned, managed and controlled by one or more information processing systems 10 which sends commands to and receives feedback from the traveling autonomous vehicles 30 and 40 via the wireless communication modules 16 of the information processing system and 23 of each traveling autonomous vehicle.

Although the foregoing descriptions of the preferred embodiments of the present inventions have shown, described, or illustrated the fundamental novel features or principles of the inventions, it is understood that various omissions, substitutions, and changes in the form of the detail of the methods, elements or apparatuses as illustrated, as well as the uses thereof, may be made by those skilled in the art without departing from the spirit of the present inventions. Hence, the scope of the present inventions should not be limited to the foregoing descriptions. Rather, the principles of the inventions may be applied to a wide range of methods, systems, and apparatuses, to achieve the advantages described herein and to achieve other advantages or to satisfy other objectives as well.

We claim:

1. An information processing system for intelligent transportation comprising
One or more data modules that accept and/or store information of packages that are currently being transported and the traveling autonomous vehicles they are on, and packages that are scheduled to be transported and their origin and destination;
One or more planning and controller modules that comprise several submodules including a sub-module that computes a plan for two or more autonomous vehicles carrying packages whereas the plan includes one or more of traveling route of each vehicle; time information of the trip of each vehicle; speed and lane position of the autonomous vehicles during the trip to enable the connection or contact of two or more traveling autonomous vehicles for the transfer of package(s); where and when two traveling autonomous vehicles complete a transfer, and whereas where, when and how packages to one or more destinations are to be transferred to another traveling autonomous vehicle; and sub-module that manages the wireless communication with two or more traveling autonomous vehicles and/or tracking devices to collect information from and transmit information to such vehicles and/or packages, to communicate information to two or more autonomous vehicles for them to execute the plan, and to receive updates from the two or more traveling autonomous vehicles and/or tracking devices in the autonomous vehicles, whereas the one or more planning and controller modules adapts the plan based on the received updates;
Whereas the one or more planning and controller modules manage the execution of the transfer of packages between two or more autonomous vehicles and initiates the connection or contact of the vehicles.

2. The information processing system of claim 1 further comprising one or more match processing modules that match packages that have overlapping traveling route(s), and/or require transportation in overlapping time.

3. The information processing system of claim 1 whereas the one or more planning and controller modules produce a plan in which a traveling small capacity autonomous vehicle is connected to a traveling larger capacity autonomous vehicle for packages in the traveling small capacity autonomous vehicle to be transferred to the larger capacity autonomous vehicle, or for packages in the traveling large capacity autonomous vehicle to be transferred to the small capacity autonomous vehicle.

4. A method of delivery of a package comprising
Transporting in a first traveling autonomous vehicle a package to be delivered to a destination or recipient;
Computing a plan for two or more traveling autonomous vehicles to carry out a transfer of a package from the first traveling autonomous vehicle to a second traveling autonomous vehicle;
Receiving updates from a plural of autonomous vehicles and/or devices embedded in packages carried by the plural of autonomous vehicles and adapting the plan based on the received updates;
Communicating the plan to the two traveling autonomous vehicles for them to execute the plan;
Controlling, according to the plan, the first traveling autonomous vehicle to travel a first route that will bring it to be immediately adjacent to the second traveling autonomous vehicle which is traveling on a second route that will reach or get close to the destination or recipient, or in which the recipient is traveling;
Controlling the first traveling autonomous vehicle and the second traveling autonomous vehicle to be immediately adjacent to each other, and,
Using a connecting, contacting or transferring mechanism to transfer the package from the first traveling autonomous vehicle to the second traveling autonomous vehicle or to deliver the package to the recipient in the second traveling autonomous vehicle.

5. The method of claim 4 further comprising obtaining the signature from recipient traveling in the second traveling autonomous vehicle.

6. The method of claim 4 further comprising one or more traveling autonomous vehicles carrying packages for delivery to a plural of destinations in addition to the first and second traveling autonomous vehicles; and updating the routes of one or more traveling autonomous vehicles the based on the destinations of the packages carried by the vehicles to improve the delivery of the packages to their intended destinations, including reducing the cost or the delivery time of one or more of the packages.

7. The method of claim 4 further comprising using a mechanical mechanism to physically connect the first and second traveling autonomous vehicles into one virtual vehicle to complete the transfer or delivery of one or more packages, whereas the two connected vehicles travel as one combined vehicle under common or coordinated control.

8. The method of claim 4 whereas using a connecting, contacting or transferring mechanism to transfer or deliver the package comprising either one or both of the first and the second traveling autonomous vehicles extend out a connecting, contacting or transferring mechanism, and the first and second traveling autonomous vehicles coordinate their control to complete the transfer of one or more of packages.

9. The method of claim 8 whereas the connecting, contacting or transferring mechanism uses a robotic arm.

10. The method of claim 8 whereas the connecting, contacting or transferring mechanism uses magnetic force.

11. The method of claim 4 further comprising the two traveling autonomous vehicles first establishing communication, aligning their travel, coming into proximity of each other, establishing physical contact or connection, maintaining communication and coordinating travel at the same or approximately the same speed and direction after the contact or connection is established, then completing the delivery, transfer or exchange of packages, retracting the connection or contact, separate, and finally travelling independently on each's own route.

12. The method of claim 4 whereas one of the traveling autonomous vehicles is an aerial vehicle.

13. The method of claim 12 further comprising using the aerial traveling autonomous vehicle picking up a package from a land traveling autonomous vehicle at one side; flying over a unfavorable segment of land route; and transferring the package to another land traveling autonomous vehicle at the other side, which continues the transportation of the package.

14. An autonomous vehicle comprising
A package compartment that can hold one or more packages;
A package transfer mechanism that retrieves a package to be transferred from the package compartment, connects or contacts with one or more other autonomous vehicles for transfer of packages, transfers the package to and/or receive a package from another traveling autonomous vehicle;
A controller module that keeps a record of the locations of the packages inside the package compartment, controls engagement and disengagement of the package transfer mechanism, and the transfer of packages;
A wireless communication module to communicate with one or more information processing systems that plan and manage the transfer of packages between traveling autonomous vehicles;
A sensor module that provides the sensory information to the controller module;
A vehicle-to-vehicle communication module that communicates with the traveling autonomous vehicle with which a package transfer is to be completed;
An energy storage module and/or a power module; and,
A drive mechanism that converts energy to produce mechanical motion to propel the autonomous vehicle.

15. The autonomous vehicle of claim 14 further comprising an in-vehicle communication module that communicates with tracking devices embedded with package(s) to track or monitor the package(s) on-board in the package compartment.

16. The autonomous vehicle of claim 14 whereas the package transfer mechanism uses a robotic arm.

17. The autonomous vehicle of claim 14 whereas the package transfer mechanism uses a magnetic force.
